(19) United States
(12) Patent Application Publication
(10) Pub. No.: US 2012/0303599 A1
(43) Pub. Date: Nov. 29, 2012

(54) DYNAMICALLY-CREATED LANDING WEBPAGE

(75) Inventor: DIPAK PATIL, MAHARASHTRA (IN)

(73) Assignee: MICROSOFT CORPORATION, REDMOND, WA (US)

(21) Appl. No.: 13/115,879

(22) Filed: May 25, 2011

(51) Int. Cl. G06F 17/30

(52) U.S. Cl. 707/706; 707/E17.108

(57) ABSTRACT

Subject matter described herein is related to providing a landing webpage having dynamically generated content, which is deemed relevant to a search query submitted to a search engine. For example, a client device submits a search query to a search engine, which provides a list of webpage addresses. One of the webpage addresses, which includes the search query embedded therein, is selected on the client device, which sends a request to a landing server. The landing server parses the request to identify the search query and searches website-specific content in real time to dynamically generate website-specific content relevant to the search query. The dynamically generated content is included in the landing webpage, thereby providing a landing webpage having dynamically generated content.

### BACKGROUND

An Internet user often attempts to locate information by submitting a search query to a search engine. The search engine typically applies a search algorithm to a set of stored information that has been previously collected and indexed to identify web pages deemed relevant to the search query. Once web pages have been identified from the previously collected information, the search engine provides a search-results webpage that presents a listing of the web pages. The user can then select one of the webpage addresses from among the listing, thereby enabling navigation to a landing webpage.

While the search engine can often determine that a website includes information relevant to a search query, and can even point the user to a specific web page, the search engine might not be able to point the user to specific information of the website (e.g., website-specific search results, information included on the website after the website has been indexed by the search engine, etc.) that is relevant to the search query.

### SUMMARY

A high-level overview of various aspects of the invention are provided here for that reason, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. In brief and at a high level, this disclosure describes providing a landing webpage having dynamically generated content, which is deemed relevant to a search query submitted to a search engine. For example, a landing-webpage server might search website-specific content in real time in response to a request (e.g., from a client computing device) to send a landing webpage.

### BRIEF DESCRIPTION OF THE DRAWINGS

Illustrative embodiments of the present invention are described in detail below with reference to the attached drawing figures, wherein:

FIG. 1 depicts an exemplary computing environment;

FIG. 2 depicts exemplary communications that might be exchanged between various components, as well as, various actions taken by those components; and

FIGS. 3 and 4 each depict a respective flow diagram outlining an exemplary method.

### DETAILED DESCRIPTION

Subject matter of select embodiments of the present invention is described with specificity herein to meet statutory requirements. But, the description itself is not intended to define what is regarded as the invention, which is what the claims do. The claimed subject matter might be embodied in other ways to include different steps or combinations of steps similar to the ones described in this document, in conjunction with other present or future technologies. Terms should not be interpreted as implying any particular order among or between various steps herein disclosed, unless and except when the order of individual steps is explicitly stated.

Subject matter described herein is related to providing a landing webpage having dynamically generated content, which is deemed relevant to a search query submitted to a search engine. As used in this description, “landing webpage” refers to a web page provided to a client computing device when a webpage address is selected from among a listing of search results. For example, when a user submits a search query to a search engine, the client computing device receives and presents a listing of search results. Then, when a user selects one of the webpage addresses included in the listing of search results, the client computing device sends a request to a landing server to provide a landing webpage. Accordingly, subject matter described herein includes a landing server that identifies content in real time that is deemed relevant to the search query and that is included in the landing webpage.

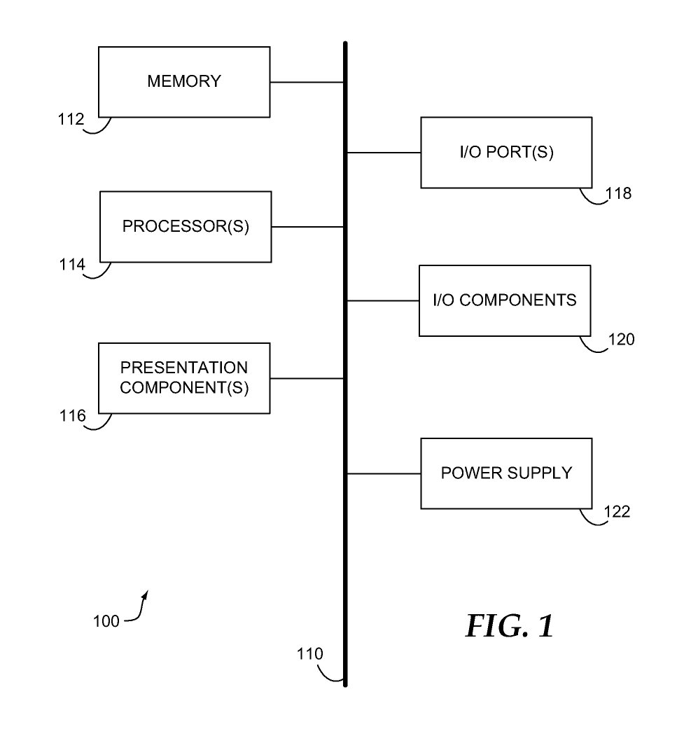

Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of invention embodiments. Neither should the computing environment 100 be interpreted as having any dependency or requirement relating to any one or combination of components illustrated.

Embodiments of the invention might be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention might be practiced in a variety of system configurations, including hand-held devices, consumer electronics, general-purpose computers, more specialty computing devices, etc. Embodiments of the invention might also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what might be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one might consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media.

Computer storage media includes volatile and nonvolatile, non-transitory, removable and non-removable media, implemented in any method or technology for storage of information such as computer-readable instructions, data structures, program modules or other data. Computer storage media includes RAM; ROM; EEPROM; flash memory or other memory technology; CD-ROM; digital versatile disks (DVD) or other optical disk storage; magnetic cassettes, magnetic tape, and magnetic disk storage or other magnetic storage devices, each of which can be used to store the desired information and which can be accessed by computing device 100.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media, such as a wired network or direct-wired connection, and wireless media, such as acoustic, RF, infrared and other wireless media. Combinations of any of the above should also be included within the scope of computer-readable media.

Memory 112 includes computer-storage media in the form of volatile and/or nonvolatile memory. The memory might be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which might be built in. Illustrative components include a microphone, joystick, game pad, satellite dish, scanner, printer, wireless device, etc.

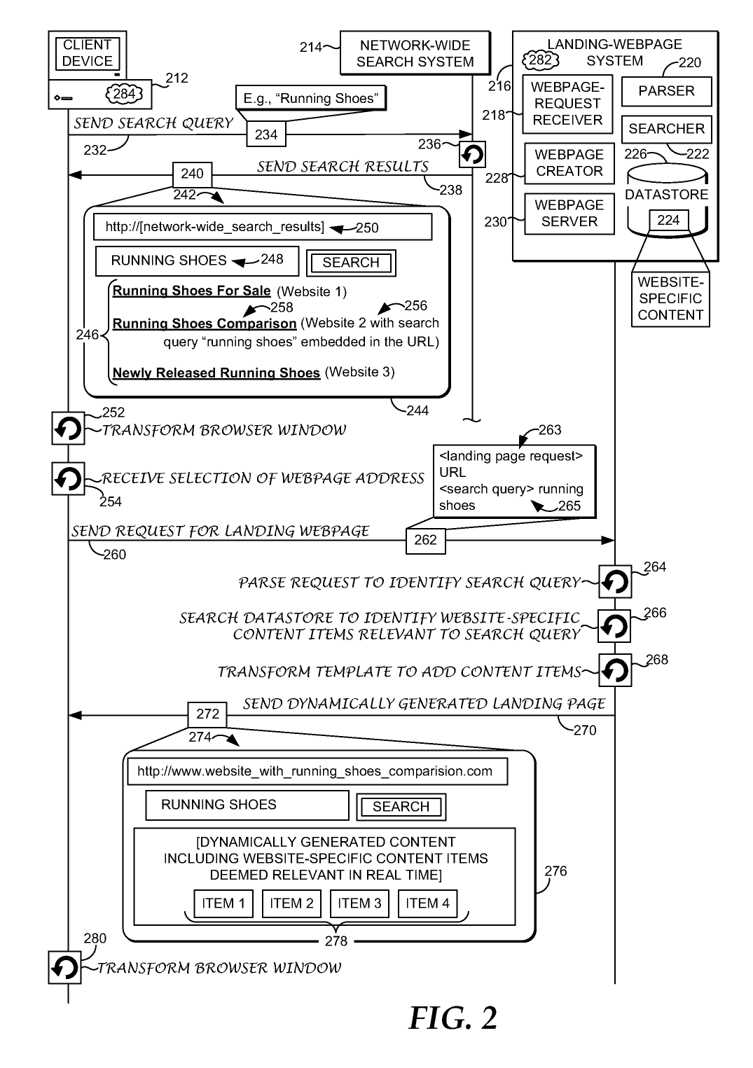

Referring now to FIG. 2, various components are depicted that communicate with one another and that include a client computing device 212, a network-wide search system 214, and a landing-webpage system 216. These components might communicate over a network (e.g., the Internet) using various known protocols. In addition, these components might communicate in various scenarios. For example, client computing device 212 might communicate with network-wide search system 214 when client computer device 212 sends a search query to network-wide search system 212 and when network-wide search system 214 provides a listing of search results to client computing device 212. Moreover, client computing device 212 might communicate with landing-webpage system 214 when client computing device 212 requests and receives a webpage that is served by landing-webpage system 216.

Client computing device 212 might include any of a variety of devices, such as the computing device described with respect to FIG. 1. Client computing device 212 includes input devices that allow a user to provide input (e.g., search query, URL selection, etc.), such as a mouse, keyboard, touch screen, and microphone. In addition, client computing device includes output devices, such as a monitor or display screen and a speaker. Client computing device 212 also includes various applications and programs that are executed using processor and computer storage media. For example, client computing device 212 includes a browser that facilitates request and receipt of various information (e.g., web pages) over the network.

Network-wide search system 214 might include various components that perform various functions related to receiving and responding to search queries and exemplary network-wide search systems include the BING™ search system. Search-system components might include indexes that organize and store information retrieved by automatic indexers (e.g., web crawlers). In addition, search-system components typically include search-engine computing devices that apply a search algorithm to the indexed information in order to identify information (e.g., various web pages that are accessible over the Internet) deemed relevant to a search query.

Landing-webpage system 216 includes various components that work together to provide a landing webpage to client computing device 212. For example, landing-webpage system 216 includes a webpage-request receiver 218 that receives requests to send webpages served by landing-webpage system 216. Landing-webpage system 216 also includes a parser 220, which parses requests that are received from client computing devices and that request landing-webpage system 216 to send a webpage. Landing-webpage system 216 further includes a searcher 222 that applies a search algorithm to website-specific content 224, which is stored and organized in datastore 226. Execution of the search algorithm enables landing-webpage system 216 to deem certain website-specific content relevant to a search engine. As such, webpage creator 228 can add the relevant website-specific content to a pre-configured landing-webpage template. Webpage server 230 (i.e., landing server) functions to send the dynamically created landing webpage (i.e., dynamically created by adding relevant content) to a requesting client computing device.

Having briefly described client computing device 212, network-wide search system 214, and landing-webpage system 216, now described is a series of communications that are exchanged between these components when a dynamically created landing webpage is provided. At step 232, a search query 234 (e.g., “running shoes”) is sent from client computing device 212 to network-wide search system 214. At action 236, network-wide search system 214 deems certain web content to be relevant to search query 234. For example, network-wide search system 214 applies a search algorithm to indexed information to identify a set of web pages deemed relevant to search query 234.

Step 238 includes sending information 240 that includes a listing of search results 246 and that is received by client computing device 212. Exemplary listing of search results 246 is depicted in an exploded view 242, which include an exemplary browser window 244 that might be displayed by client computing device 212. Browser window 244 illustrates a listing of search results 246 that is presented together with a search query 248 and a webpage address 250 of the search-results webpage. Browser window 244 also indicates (i.e., reference numeral 256) that the content of search query 234 (i.e., “running shoes”) has now been embedded in webpage address 258.

At step 252, client computing device 212 transforms a browser window to include the listing of search results 246, such as by displaying exemplary browser window 244. At step 254, client computing device 212 receives a selection of one of the webpage addresses that are presented in the browser window. For example, a user might use an input device (e.g., a mouse and cursor, a touch screen, etc.) to select webpage address 258, which has the content of search query 234 embedded therein.

In response to receiving the selection of the webpage address 258, at step 260 client computing device 212 sends to landing-webpage system 216 information 262, which includes a request 263 to send a landing webpage and includes search query 265 (“running shoes”). That is, when the webpage address 258 that is selected has been coded to include the content of the search query 234 embedded therein (i.e., as indicated by reference numeral 256), then request 263 also includes the search query 265, which matches search query 234. As such, in the example of FIG. 2, request 263 might include “running shoes.”

Landing-webpage system 216 receives request 263 to send the landing webpage, such as by executing webpage-request receiver 218. As previously defined, the landing webpage is a webpage of a website that is provided when a webpage address is selected on a client computing device. Action 264 includes parsing the request to identify a search term embedded therein. For example, parser 220 might parse request 262 to identify “running shoes.”

Absent subject matter describe herein, landing-webpage system 216 might proceed at this point by simply retrieving a stored webpage that includes pre-determined content, such that dynamically generated content is not provided to client 212. However, landing-webpage system 216 described herein takes additional actions to provide dynamically generated content that is identified in real time (i.e., when request 263 is received). For example, action 266 includes querying datastore 226 to identify content items that are included among content of the website and that are deemed relevant to the search term. To deem content items relevant, searcher 222 might apply a search algorithm to website-specific content 224 to identify content items that are relevant to “running shoes.” The website-specific content 224 might be limited to content that is included within a website. For example, website-specific content 224 might be limited to content that is included within a website that includes the webpage identified by webpage address 258. In addition, searcher might be coded to only search content included within a website to which webpage address 258 belongs.

After certain content items are deemed relevant, at action 268 webpage creator 228 transforms a webpage template to add the content items, thereby dynamically creating a landing webpage. For example, a webpage template might include some pre-configured content (e.g., menu items, tabs, etc.), as well as fillable content blocks that can receive content in real time. At step 270, information 272 that includes the dynamically created landing webpage is provided to client computing device 212, such as by webpage server 230. Information 272 is depicted in an exploded view 274 for illustrative purposes and includes an exemplary landing webpage 276. Exemplary landing webpage 276 includes a plurality of content items 278 that were retrieved from datastore 226 in real time when the content items 278 were deemed relevant to the search query.

Upon receiving information 272 from the webpage server 230, client computing device 212 transforms 280 a browser window (e.g., the browser window that previously displayed the listing of search results) to include a dynamically generated landing webpage. For example, dynamically generated landing webpage 276 includes website-specific search results 278 that were deemed relevant to the search query 234.

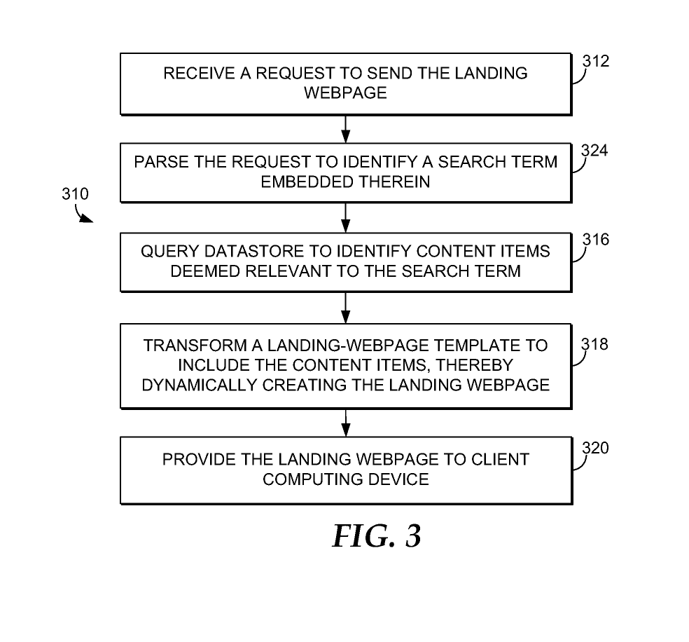

Referring now to FIG. 3, a flow diagram depicts a method 310 that is executed by landing-webpage system 216. That is, landing-webpage system 216 might include computer storage media 282 having computer-executable instructions embodied thereon that, when executed, facilitate method 310 of providing a landing webpage (e.g., 276) having dynamically generated content (e.g., 278), which is deemed relevant to a search query (e.g., 234) submitted to a search engine (e.g., 214). When describing method 310, reference will also be made to FIG. 2 for explanatory and illustrative purposes.

Method 310 includes at step 312, receiving by a landing server a request to send the landing webpage, the landing webpage including a webpage of a website that is provided when a webpage address is selected on a client computing device. For example, landing-webpage system 216 receives request 262, which includes a request to send a landing webpage identified by selected webpage address 258.

At step 314, the request is parsed to identify a search term embedded therein. For example, parser 220 parses request 262 to identify search query 265, which is embedded in the request 262 as a result of search query 234 being embedded in webpage address 258. Step 316 includes querying a datastore to identify content items that are included among content of the website and that are deemed relevant to the search term. For example, searcher applies a search algorithm to datastore 226 to identify content items 278 that are included among website-specific content 224 and that are deemed relevant to “running shoes.”

Method 310 continues with step 318, at which point a landing-webpage template is transformed to include the content items that are deemed relevant to the search term, thereby dynamically creating the landing webpage. For example, webpage creator 228 transforms a webpage template to add content items 278 deemed relevant to “running shoes,” thereby dynamically creating landing webpage 276. Step 320 includes providing the landing webpage that is dynamically created to the client computing device. For example, landing webpage 276 is provided by server 230 to client computing device 212.

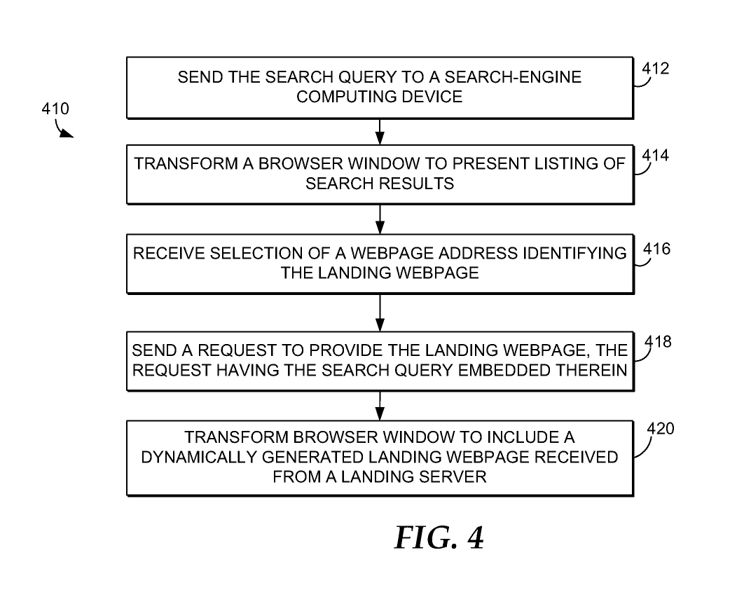

Referring now to FIG. 4, a flow diagram depicts a method 410 that is executed by client computing device 212. That is, client computing device 212 might include computer storage media 284 having computer-executable instructions embodied thereon that, when executed, facilitate method 410 of providing a landing webpage (e.g., 276) having dynamically generated content (e.g., 278), which is deemed relevant to a search query (e.g., 234) submitted to a search engine (e.g., 214). When describing method 410, reference will also be made to FIG. 2 for explanatory and illustrative purposes.

Method 410 includes at step 412 sending the search query to a search-engine computing device, wherein a listing of search results is received from the search-engine computing device in response to the search query. For example, client computing device 212 sends search query 234 (e.g., “running shoes”) to network-wide search system 214, and client computing device 212 receives from search system 214 information 240 that includes a listing of search results.

At step 414, method 410 includes transforming a browser window to present the listing of search results. For example, client computing device 212 might transform a browser window to include search-results webpage 244, which includes the listing of search results 246. Step 416 includes receiving a selection of a webpage address that identifies the landing webpage and that is included among the listing of search results. For example, client computing device 212 might receive a selection of webpage address 258 that identifies a landing webpage (to be subsequently received by client computing device 212) and that is included among listing 246.

Method 410 includes at step 418 sending to a landing server a request to provide the landing webpage, wherein the search query is embedded in the request. For example, client computing device 212 sends information 262 to landing-webpage system 216, the information 262 including a request for a landing webpage and the search query “running shoes.” In response to the request in information 262, client computing device 212 receives information 272, which includes a dynamically generated landing webpage 276.

As such, step 420 includes transforming the browser window (e.g., the browser window that previously presented listing 246) to include a dynamically generated landing webpage that is received from the landing server. The dynamically generated landing webpage includes website-specific search results that are deemed relevant to the search query in real time in response to the request to provide the landing webpage. For example, a browser window might be transformed to present dynamically generated webpage 276.

The above subject matter describes providing a landing webpage that includes dynamically generated content that is deemed relevant to a search query in real time. Absent subject matter described herein, a landing server might only provide pre-configured content that fails to include dynamically generated content, which might not be indexed by the search engine.

Many different arrangements of the various components depicted, as well as components not shown, are possible without departing from the scope of the claims below. Embodiments of our technology have been described with the intent to be illustrative rather than restrictive. Alternative embodiments will become apparent readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

Claimed is:

1. Computer-storage media having computer-executable instructions embodied thereon that, when executed, perform a method of providing a landing webpage having dynamically generated content, which is deemed relevant to a search query submitted to a search engine, the method comprising:
receiving by a landing server a request to send the landing webpage, wherein the landing webpage is a webpage of a website that is provided when a webpage address is selected on a client computing device;
parsing the request to identify a search term embedded therein;
querying a datastore to identify content items that are included among content of the website and that are deemed relevant to the search term;
transforming a landing-webpage template to include the content items that are deemed relevant to the search term, thereby dynamically creating the landing webpage; and
providing the landing webpage that is dynamically created to the client computing device.

2. The computer-storage media of claim 1, wherein the webpage address that is selected is listed on a search-results webpage.

3. The computer-storage media of claim 2, wherein the search term that is identified within the request was submitted to the search engine, thereby eliciting the search-results webpage.

4. The computer-storage media of claim 1, wherein all of the content items are included within the website that is served by the landing server.

5. The computer-storage media of claim 4, wherein all of the content items are deemed relevant to the search query in real time in response to selection of the webpage address on the client computing device.

6. The computer-storage media of claim 1, wherein querying the database includes applying a search algorithm to a collection of content that is included within the website, and wherein the search algorithm is not applied to non-website content that is not included within the website.

7. The computer-storage media of claim 1, wherein a search component, which deems the content items to be relevant, is programmed to include a searchable scope that is limited to the website.

8. The computer-storage media of claim 1, wherein querying the datastore is prompted when the request is received from the client computing device, and wherein the request is sent by the client computing device when the client computing device receives a selection of the webpage address.

9. Computer-storage media having computer-executable instructions embodied thereon that, when executed, perform a method of providing a landing webpage having dynamically generated content, which is deemed relevant to a search query submitted to a search engine, the method comprising:
sending the search query to a search-engine computing device, wherein a listing of search results is received from the search-engine computing device in response to the search query;
transforming a browser window to present the listing of search results;
receiving a selection of a webpage address that identifies the landing webpage and that is included among the listing of search results;
sending to a landing server a request to provide the landing webpage, wherein the search query is embedded in the request; and
transforming the browser window to include a dynamically generated landing webpage that is received from the landing server,
wherein the dynamically generated landing webpage includes website-specific search results that are deemed relevant to the search query, and
wherein the website-specific search results are deemed relevant by the landing server in real time in response to the request to provide the landing webpage.

10. The computer-storage media of claim 9, wherein the dynamically generated landing webpage is received from the landing server in response to the selection of the webpage address from the listing of search results.

11. The computer-storage media of claim 9, wherein each search result of the website-specific search results identifies content that is included within a same website to which the webpage address belongs.

12. The computer-storage media of claim 9, wherein a client computing device prompts the landing server to identify the website-specific search results when the selection of the webpage address is received by the client computing device.

13. The computer-storage media of claim 9, wherein the webpage address, which identifies the landing webpage among the listing of search results, includes the search query embedded therein, thereby enabling the request to include the search query when the request is sent from a client computing device to the landing server.

14. The computer-storage media of claim 9, wherein the request that includes the search query embedded therein is sent to the landing sever in response to the selection of the webpage address.

15. A system that includes a processor coupled to computer-storage media and that provides a landing webpage having dynamically generated content, which is deemed relevant to a search query submitted to a search engine, the system including:
a webpage-request receiver that receives a request to send a landing webpage;
a parser that leverages the processor to parse the request to identify a search query embedded in the request;
a search component that leverages the processor to search website-specific content stored on the computer-storage media to identify content items that are deemed relevant to the search query;
a webpage creator that leverages the processor to dynamically generate the landing webpage in real time by adding the content items to a landing-webpage template; and
a webpage server that provides the landing webpage including the content items to the client computing device.

16. The system of claim 15, wherein the webpage-request receiver receives the request from a client computing device in response to a selection of a webpage address, which is listed on a search-result webpage displayed by the client computing device.

17. The system of claim 16, wherein the search-result webpage is generated by a search engine in response to the client computing device sending the search query to the search engine.

18. The system of claim 15, wherein all of the website-specific content that is searched is included within a website to which the landing webpage belongs.

19. The system of claim 15, wherein the search component is prompted to search the website-specific content to identify the content items in response to receiving the request to send the landing page, and wherein the request to send the landing page is received when a webpage address is selected on a search-results webpage.

20. The system of claim 15, wherein the content items are added to the landing-webpage template as website-specific search results that are automatically generated in real time.
